(19) United States
(12) Patent Application Publication
(10) Pub. No.: US 2026/0289039 A1
(43) Pub. Date: Sep. 24, 2026

(54) RECONFIGURABLE MODEL-BASED SIMULATOR

(71) Applicant: KOREA AEROSPACE RESEARCH INSTITUTE, Daejeon (KR)

(72) Inventors: Sung-Ryoung LEE, Daejeon (KR); Kwang-Soo KIM, Daejeon (KR); Jin-Ho SEO, Daejeon (KR); Hyo Young LEE, Daejeon (KR)

(73) Assignee: KOREA AEROSPACE RESEARCH INSTITUTE, Daejeon (KR)

(21) Appl. No.: 19/403,617

(22) Filed: Nov. 28, 2025

(30) Foreign Application Priority Data
Mar. 20, 2025 (KR) 10-2025-0036244

(51) Int. Cl. G06F 30/20

(52) U.S. Cl. CPC G06F 30/20

(57) ABSTRACT

The invention relates to a reconfigurable model-based simulator. The simulator includes one or more memories, one or more processors, and one or more IO hardware configured to perform input and output simulation of a simulation target system. The memory stores simulator software including a model section having one or more logic models configured to simulate respective functional elements of the simulation target system and a main controller section configured to control simulation according to user control commands. A portion of the memory is allocated as shared memory for sharing input and output data between the logic models and the IO hardware, and the shared memory includes respective shared memory regions individually allocated to the logic models. A main program process of the main controller section executed by the processors performs sharing of the input and output data through the shared memory regions.

### CROSS-REFERENCE TO RELATED APPLICATION

This application claims priority to Korean Patent Application No. 10-2025-0036244, filed in the Korean Intellectual Property Office on Mar. 20, 2025, the entire contents of which are hereby incorporated by reference.

### STATEMENT REGARDING PRIOR DISCLOSURES BY THE INVENTOR OR A JOINT INVENTOR

Applicant hereby states under 37 CFR 1.77(b)(6) that Sung-Ryoung Lee et al., “Reconfigurable Software Design of Model-Based Launch Vehicle Simulator for Ground Control System”, 75th International Astronautical Congress (IAC), Milan, Italy, published on 14-18 Oct. 2024, is designated as a grace period inventor disclosure. The disclosure: (1) was made one year or less before the effective filing date of the claimed invention; (2) names the inventor or a joint inventor as an author; and (3) does not name additional persons as authors on a printed publication.

### BACKGROUND

### Field of the Invention

The present invention relates to a reconfigurable model-based simulator.

### Description of Related Art

A launch vehicle requires verification of launch operation, including interface verification with a Ground Control System (GCS) located beneath a launch pad, in order to perform launch operations. However, it is very difficult to transport an actual launch vehicle to the launch pad and connect it directly to the GCS for interface verification. As a solution to this problem, a launch vehicle simulator may be used instead of the launch vehicle.

Most existing simulator software, including launch vehicle simulators, has limitations in that it is designed for a specific purpose and thus difficult to reconfigure and reuse. The flexibility and scalability of simulator software have been significantly restricted due to a dependent software architecture in which data and control parameters are mixed, design limited to a specific OS or 32/64-bit environment causing compatibility issues, and a restricted user access environment that does not allow users to configure the UI in a desired manner. As such, a simulator designed for a particular purpose is difficult to modify for a different use, resulting in recurring costs and time consumption for developing new simulator software for each use case.

### SUMMARY

The technical problem to be solved by the present invention is to provide a simulator implemented with reconfigurable model-based simulator software, and a non-transitory computer-readable recording medium having the simulator software recorded thereon.

To achieve the foregoing technical objective, a simulator according to the present invention include one or more memories, one or more processors, and one or more IO hardware configured to perform input and output simulation of a simulation target system.

A portion of the one or more memories may store simulator software, and the simulator software may include a model section comprising one or more logic models configured to simulate respective functional elements of the simulation target system, and a main controller section configured to perform a simulation control function for the simulation target system according to user control commands.

A portion of the one or more memories may be allocated as shared memory for sharing input and output data between the one or more logic models and the one or more IO hardware.

The shared memory may include respective shared memory regions individually allocated to the one or more logic models, and a main program process of the main controller section executed by the one or more processors may perform sharing of the input and output data.

The simulator software may further include an IO section configured to perform an IO hardware control function for controlling the one or more IO hardware, and a MAP section configured to perform a mapping control function of generating and managing a mapping table between a memory of the one or more IO hardware and data processed by the one or more logic models.

A portion of the one or more memories may include a shared memory region for data use for addition, modification, and management of the one or more logic models by a user and for execution of the one or more logic models, and a shared memory region for control use for execution of the main controller section, the IO section, and the MAP section.

The shared memory allocated as the shared memory regions for data use and for control use may be configured in a memory map form.

The model section may provide an environment for designing logic and data input/output interfaces of one or more logic models for simulating respective functional elements of the simulation target system based on data of the shared memory region for data use and the shared memory region for control use.

The simulator software may further include a UI section configured to provide a user interface that allows a user to add, modify, and manage the one or more logic models, set data mappings between the one or more logic models and the one or more IO hardware, and control and monitor a simulation according to user requirements.

The UI section may control UI components constituting the user interface in association with control parameters stored in the shared memory and data processed by the one or more logic models.

The shared memory allocated as the shared memory regions for data use and for control use may be referenced, displayed, and manipulated by the UI section.

The one or more logic models may be implemented as logic model processes that are independently executed.

The logic model processes may be executed independently of processes of the main controller section, the IO section, and the MAP section.

A main program including the main controller section, the IO section, and the MAP section may be implemented as a single process.

A shared memory region for addition, modification, and management of the one or more logic models by a user and for execution of the one or more logic models.

A shared memory region for execution of the main controller section, the IO section, and the MAP section may be independently allocated and managed.

MAP setting files for mapping control and IO setting files for IO hardware control may be delivered to a process of the main controller section through a path via the shared memory.

MAP setting files for mapping control and IO setting files for IO hardware control may be directly loaded and processed by the process of the main controller section without passing through the shared memory.

Processes of the simulator software may be configured to operate based on POSIX (Portable Operating System Interface) system call interface, System V system call interface, or Win32 API system call interface.

The one or more logic models may be individually allocated respective shared memory regions based on respective IDs, and data sharing between the one or more logic models may be performed through the shared memory regions.

According to the present invention, a reconfigurable model-based simulator can be provided, which is capable of being modified and adapted depending on a simulation target system. Accordingly, simulator development costs and time can be reduced. Furthermore, by adopting a design utilizing a general-purpose system call interface, hardware performance scalability and long-term maintainability can be ensured.

### BRIEF DESCRIPTION OF THE DRAWINGS

The above and other objects, features and advantages of the present disclosure will become more apparent to those of ordinary skill in the art by describing in detail exemplary embodiments thereof with reference to the accompanying drawing, in which:

FIG. 1 is a diagram schematically illustrating a hardware configuration of a reconfigurable model-based simulator according to an embodiment of the present invention;

FIG. 2 is a diagram provided to explain a configuration of simulator software according to an embodiment of the present invention;

FIG. 3 is a diagram provided to explain a function of adding or deleting a logic model based on shared memory according to an embodiment of the present invention;

FIG. 4 is a diagram provided to explain an example in which a design separating a control path and a data path of simulator software is applied according to an embodiment of the present invention;

FIG. 5 is a diagram illustrating an example in which simulator software is installed on new hardware and used when a hardware failure occurs in a simulator according to an embodiment of the present invention.

### DETAILED DESCRIPTION

Hereinafter, certain embodiments will be described in detail with reference to the accompanying drawings to help those with ordinary knowledge in the art easily achieve the present disclosure.

The terms are used herein for the purpose of describing the embodiments and not intended to limit the present disclosure. In the description, a singular expression also includes a plural expression unless specifically stated otherwise in the context. The terms “comprises” and/or “comprising” as used herein do not foreclose the presence or addition of one or more components other than the specified component. Throughout the description, the same reference numerals refer to the same components, and “and/or” includes each and combinations of one or more of the specified components. The terms “first”, “second”, etc. are used to describe various components, but it goes without saying that these components are not limited by these terms. These terms are only used to distinguish one component from another. Therefore, it goes without saying that a first component mentioned below may be a second component within the technical idea of the present disclosure.

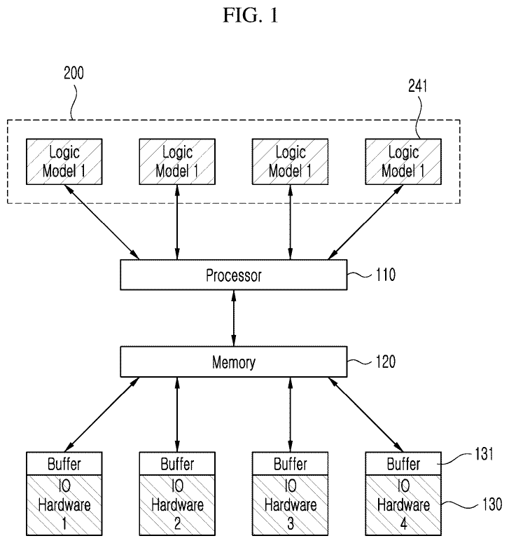

FIG. 1 is a diagram schematically illustrating a hardware configuration of a reconfigurable model-based simulator according to an embodiment of the present invention.

Referring to FIG. 1, a simulator 100 according to an embodiment of the present invention may include a processor 110, a memory 120, and IO hardware 130.

The processor 110 may execute simulator software 200 stored in the memory 120 so as to perform a simulation of a simulation target system at the simulator 100.

The simulation target system may be various systems such as an automobile, a launch vehicle, or a satellite, and a user may reconfigure and use the simulator software 200 according to the simulation target system.

The simulator software 200 may include one or more logic models 241. For convenience of illustration, FIG. 1 shows an example in which four logic models (Logic Model 1, Logic Model 2, Logic Model 3, and Logic Model 4) 241 are included in the simulator software 200; however, the number of logic models 241 included in the simulator software 200 may vary depending on the embodiment.

The logic model 241 may be a program designed to simulate each functional element constituting a simulation target system. Here, the functional element refers to an individual physical or logical component constituting the simulation target system, or a combination of such components, and means a specific functional unit to be simulated in the simulation target system by the logic model 241. For example, when the simulation target system is a launch vehicle, the simulator software 200 may include a plurality of logic models 241, and the plurality of logic models 241 may be programs designed to respectively simulate functional elements constituting the launch vehicle, such as an on-board computer (OBC), an engine valve, and a fuel gauge. When all or some of the functional elements of the simulation target system are changed, the logic models 241 included in the simulator software 200 may also be changed, added, or deleted accordingly. The simulator software 200 may be reconfigured to operate by including the changed, added, or deleted logic models 241 in accordance with the changed simulation target system.

The memory 120 may store the simulator software 200 and various information and data necessary for operation of the simulator 100. The memory 120 may include a ROM (Read Only Memory), a RAM (Random Access Memory), flash memory, a solid-state drive (SSD), a non-volatile RAM (NVRAM), and a magnetoresistive RAM (MRAM).

The IO hardware 130 may be implemented as a hardware device that simulates input/output functions of a simulation target system, and may include a buffer 131 and an input/output interface. The input/output interface may include various input/output ports such as UART, SPI, I2C, CAN, and Ethernet. For convenience of illustration, FIG. 1 shows an example in which four IO hardware (IO hardware 1, IO hardware 2, IO hardware 3, and IO hardware 4) 130 are included in the simulator 100; however, the number of IO hardware 130 included in the simulator 100 may vary depending on the embodiment.

In another embodiment, the IO hardware 130 may include a memory instead of the buffer 131. In this case, the memory of the IO hardware 130 may temporarily store input/output data in the same manner as the buffer 131, and may perform a buffering function for data exchange with the logic model 241. Therefore, the buffer 131 and the memory of the IO hardware 130 are mutually replaceable configurations, and in the present invention, the term “buffer 131” may be interpreted to encompass a portion or a corresponding region of the memory depending on the context.

The IO hardware 130 may receive data processed by a logic model 241 through a mapping table 231 and output a corresponding signal, or may process a signal input from the outside through the mapping table 231 and then deliver the processed signal to the logic model 241 on a shared memory basis through the memory 120. Specifically, data input to the simulator 100 through the IO hardware 130 may be stored in the memory 120, and the processor 110 may execute the logic model 241 based on the data stored in the memory 120 to process the data. Data processed by executing the logic model 241 at the processor 110 may then be stored in the memory 120 and delivered to the IO hardware 130.

Accordingly, in this embodiment, the simulator software 200 may be configured to interwork with the IO hardware 130 by transmitting and receiving data with the IO hardware 130 so as to perform input/output simulation of each logic model 241.

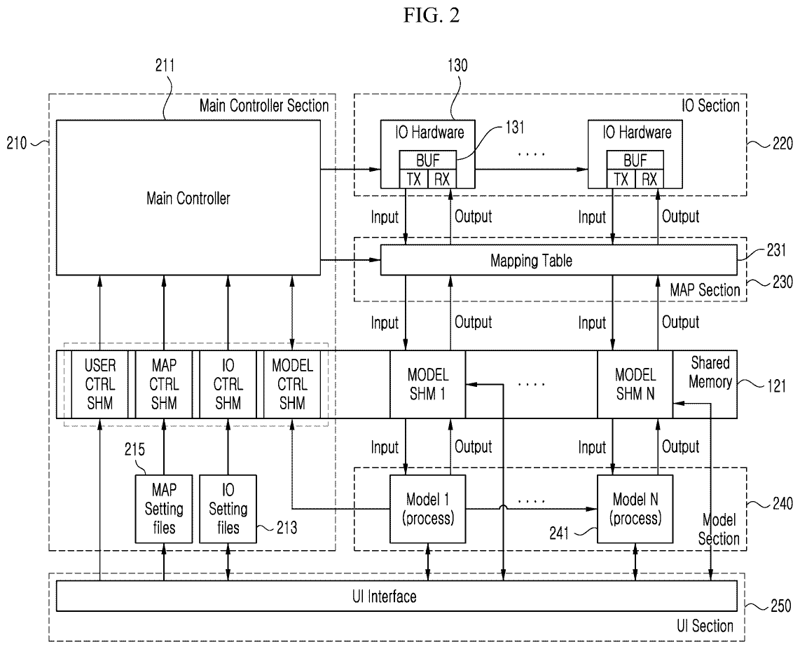

FIG. 2 is a diagram provided to explain a configuration of simulator software according to an embodiment of the present invention.

Referring to FIG. 2, simulator software 200 according to an embodiment of the present invention may include a main controller section 210, an IO section 220, a MAP section 230, a model section 240, and a UI section 250, each of which performs a role according to a functional purpose.

According to an embodiment, processes of the simulator software 200 may be separated into a main program process, a logical model process, and a UI process. The main program process may be implemented as a single process including the main controller section 210, the IO section 220, and the MAP section 230, and the model section 240 and the UI section 250 may be implemented as separate processes.

The model section 240 may include one or more logic models (Model 1, . . . , Model N) 241. In order to minimize an impact on stability of the main program, the logic models 241 included in the model section 240 may be implemented as logic model processes that are independently executed. Furthermore, the logic model processes may be designed to be executed as processes separate from the main program process of the main controller section 210, the IO section 220, and the MAP section 230.

The model section 240 may be implemented to provide an environment for designing logic (Logical Design) and data input/output interfaces (Data I/O Interface Design) of one or more logic models for simulating respective functional elements of the simulation target system, based on data of a shared-memory region for data use and a shared-memory region for control use.

Here, the logical design may include a function of defining operation logic, state transitions, and computation flows constituting each functional element of the simulation target system, and of constructing an independent control flow for each logic model.

For example, through the model section 240, a user may reproduce functional operations of the simulation target system by defining, for each logic model, input conditions, computation functions, internal variables, and output rules.

Meanwhile, the data input/output interface design may include a function of defining a data-exchange structure between logic models or between the logic models and the IO hardware 130.

Specifically, each logic model 241 may set input ports and output ports by referring to a data structure of the shared memory, and may specify data types, data sizes, transmission/reception cycles, and synchronization methods.

The model section 240 may verify connection relationships between the logic models based on such data input/output interface information and manage consistent data exchange through interworking with the mapping table 231.

Accordingly, the model section 240 may be implemented not merely as an execution area for the logic models but as a reconfigurable design environment that allows definition, verification, and modification of the logic and data interfaces of the logic models.

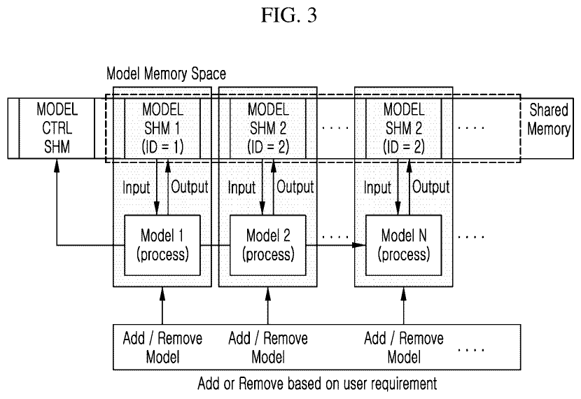

FIG. 3 is a diagram provided to explain a function of adding or deleting a logic model based on shared memory according to an embodiment of the present invention.

The model section 240 may perform a function of adding or deleting a logic model based on shared memory in order to share data with a main program. As illustrated in FIG. 3, a shared memory region (MODEL SHM 1, . . . , MODEL SHM N) may be individually allocated to each logic model 241 based on an ID, and a user may declare and modify a data structure within the corresponding shared memory region and design an operation of the logic model 241. For example, when a logic model (Model 1) is assigned with ID=1, the shared memory region (MODEL SHM 1) may be allocated thereto. Here, the data structure of the logic model may include input data information processed by the logic model (e.g., external input data such as sensor values and user-specified parameters), output data information (e.g., result data generated by the logic model, calculated control values, and simulation results), logic model parameter information (e.g., setting values required for a function performed by the logic model), and logic model execution state information (e.g., execution status and operation mode of the logic model), and the user may configure the data structure information of the logic model.

In order to share data in an internal interface design between the logic models 241, each logic model 241 may be designed to access the shared memory region by using a logic model ID so that the logic models can share data with one another.

In addition, control parameters of the logic models 241 allocated to the shared memory 121 may be designed to be controlled by the main controller 211, and for this purpose, the control parameters of the logic models may be processed by the main controller 211 through a shared memory region (MODEL CTRL SHM).

Referring again to FIG. 2, the IO section 220 is an area responsible for a function of controlling the IO hardware 130 and, as described above, may be designed as a single process together with the main controller section 210 and the MAP section 230. When the design of the IO hardware 130 is completed, user initialization setting values of the IO hardware 130 may be stored in an IO setting file (.ini file) 213. For example, in the case of a serial board, initialization setting values such as a baud rate, a start bit, a stop bit, and a parity bit may be stored. The IO setting file 213 may be processed by the main controller 211 through a shared memory region (IO CTRL SHM) and delivered to the IO section 220.

The IO section 220, after loading the IO setting file, may generate an IO hardware list, store IO hardware initialization data, and generate an IO hardware dynamic buffer and IO state control parameters. When the main program is initialized, the IO section 220 may perform configuration by applying the user initialization setting values stored in the IO hardware list. When the simulation is started, the IO hardware 130 may be controlled by state control parameters generated by the main controller 211.

The MAP section 230 may map data processed by the logic models 241 (hereinafter referred to as data of the logic models) to IO hardware buffers 131 and generate a mapping table 231. A user may configure a mapping table for mapping the data of the logic models to the IO hardware buffers 131 or to data of other logic models through a UI interface provided by the UI section 250. Specifically, the data of the logic models may be mapped to the IO hardware buffers 131 or to data of other logic models by taking into account a data transmission/reception direction in the IO hardware buffers 131 (RX: IO hardware→logic model, logic model 1→logic model 2, TX: logic model→IO hardware, logic model 2→logic model 1) and the size of the data of the logic models. The MAP section 230 may generate the mapping table 231 using MAP setting files 215 that include data mapping information between the logic models and the IO hardware buffers as defined by the user.

In addition, the MAP section 230 may be designed to set an operation cycle of each logic model based on a data synchronization time between the logic models and the IO hardware or between the logic models.

The main controller section 210 performs a function of controlling an entire simulation according to control commands of a user. For example, the main controller 211 may operate based on a built-in state diagram machine and, according to an embodiment, may provide five commands as follows.
INIT: generate and initialize logic models, IO hardware control parameters, and mapping tables
START: execute operation of a simulation main program
STOP: stop operation of the main program and clear initialization functions and state control parameters of each section
PAUSE: pause an operation of a specific logic model
RESUME: resume an operation of a specific logic model

The UI section 250 may provide a UI interface that allows a user to control and monitor a simulation. The UI section 250 may be configured to control and monitor by referencing a memory map of the shared memory and linking UI components constituting the UI interface with control parameters stored in the shared memory and data processed by the logic models. In addition, according to a user's operation, the UI section 250 may record and apply changed values of the control parameters or simulation control commands to the shared memory. To this end, the shared memory allocated as a shared-memory region for data use and a shared-memory region for control use may be configured in the form of a memory map so that it can be referenced, displayed, and manipulated (recorded and controlled) by the UI section 250.

The UI section 250 may provide a logic model editor, a mapping table design interface, and a simulation control/monitoring interface.

The logic model editor is a UI editing tool that allows a user to add, modify, and manage logic models. A user may set a structure and operation of a logic model on the logic model editor and define a data structure of the model.

The mapping table design interface is an interface that allows a user to set data mapping between the logic models and the IO hardware. The mapping table design interface may display a list of logic model data and a list of IO buffers, and a user may configure and store data mappings based on the lists. The mapping table design interface may provide functions of generating and referencing mapping data.

The simulation control and monitoring interface is an interface that allows a user to execute and stop a simulation and monitor operations of the logic models in real time. The simulation control and monitoring interface may display an overall model list and an execution state of each model. In accordance with a user's request, the simulation control and monitoring interface may adjust data emulation and monitoring of the models and configure a monitoring environment.

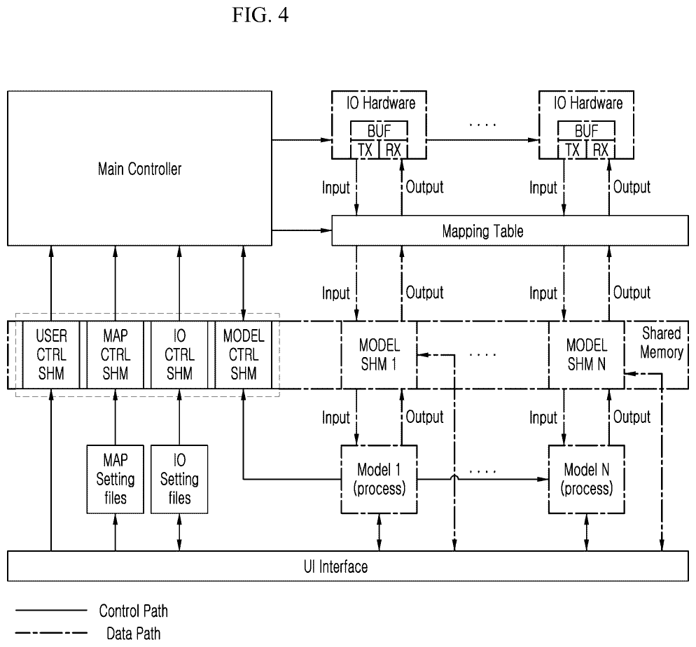

FIG. 4 is a diagram provided to explain an example in which a design separating a control path and a data path of simulator software is applied according to an embodiment of the present invention.

Referring to FIG. 4, the simulator software may apply a design in which a control path and a data path are separated. User commands for simulation control, MAP setting files for mapping control, and IO setting files for IO hardware control may be processed through the control path and managed on a shared memory basis. For this purpose, shared memory regions USER CTRL SHM, MAP CTRL SHM, and IO CTRL SHM may be allocated and used.

In addition, user settings for data structures of the logic models or data exchanges between the logic models and the IO hardware during execution of a simulation may be processed through the data path, and may also be managed on a shared memory basis. For this purpose, shared memory regions MODEL SHM 1, . . . , MODEL SHM N may be individually allocated to respective logic models. As described above, by separating the control path and the data path, shared memory regions for addition, modification, and management of logic models by a user and for execution of the logic models, and shared memory regions for execution of the main controller section, the IO section, and the MAP section may be independently allocated and managed. Through such a design, code dependency can be minimized.

In addition, according to an embodiment, it is also possible to implement a configuration in which the MAP setting files for mapping control and the IO setting files for IO hardware control are directly loaded and processed by a process of the main controller section 210 without passing through the shared memory.

The simulator software according to an embodiment of the present invention may be configured such that each process, such as a main program process, a logical model process, and a UI process, operates based on POSIX (Portable Operating System Interface) system call interface, a System V call interface, or a Win32 API call interface, so that the simulator software can be executed on most operating systems such as UNIX, Linux, and Windows. Even when an operating system is updated, stable operation may be maintained as support for new processors and libraries is added, thereby providing an advantage in terms of maintenance.

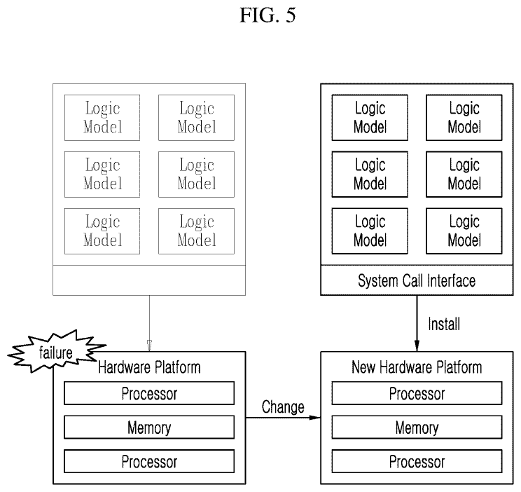

FIG. 5 is a diagram illustrating an example in which simulator software is installed on new hardware and used when a hardware failure occurs in a simulator according to an embodiment of the present invention.

Referring to FIG. 5, as shown in the example at the lower left, when a failure occurs in a hardware platform on which the simulator software is installed, the simulator software may be reinstalled and reused on a new hardware platform through a design utilizing a general-purpose system call interface, even if the hardware platform is replaced. This provides advantages in terms of hardware performance scalability and long-term maintainability.

The embodiments described above may be implemented by hardware components, software components, and/or a combination of hardware and software components. For example, the devices, methods, and components described in the embodiments may be implemented using one or more general-purpose computing devices or special-purpose computing devices, such as a processor, a controller, an arithmetic logic unit (ALU), a digital signal processor (DSP), a microcomputer, a field programmable gate array (FPGA), a programmable logic unit (PLU), a microprocessor, or any other device capable of executing and responding to instructions. A processing device may execute an operating system (OS) and one or more software applications running on the operating system. In addition, the processing device may, in response to execution of software, access, store, manipulate, process, and generate data. For convenience of understanding, the processing device has been described in some cases as a single device; however, those skilled in the art will understand that the processing device may include a plurality of processing elements and/or a plurality of types of processing elements. For example, the processing device may include a plurality of processors or one processor and one controller. Other processing configurations, such as parallel processors, are also possible.

Software may include a computer program, code, instructions, or one or more combinations thereof, and may configure a processing device to operate in a desired manner or command the processing device independently or collectively. Software and/or data may be embodied permanently or temporarily in any type of machine, component, physical device, virtual equipment, computer storage medium, or device, in order to be interpreted by a processing device or to provide instructions or data to the processing device. Software may be distributed across computer systems connected through a network, so as to be stored or executed in a distributed manner. Software and data may be stored in one or more computer-readable recording media.

A method according to an embodiment may be implemented in the form of program instructions executable through various computer means and recorded on a computer-readable storage medium. The computer-readable storage medium may include program instructions, data files, and data structures, alone or in combination. The program instructions recorded on the medium may include those specially designed and configured for the embodiments or those publicly known and available for use by persons skilled in the art of computer software. Examples of the computer-readable recording medium include magnetic media such as a hard disk, a floppy disk, and magnetic tape, optical media such as CD-ROM and DVD, magneto-optical media such as a floptical disk, and hardware devices specially configured to store and execute program instructions such as ROM, RAM, flash memory, SSD (Solid-State Drive), NVRAM (Non-Volatile RAM), and MRAM (Magnetoresistive RAM). Examples of program instructions include machine code created by a compiler as well as high-level language code that can be executed by a computer using an interpreter. The above-described hardware devices may be configured to operate as one or more software modules to perform the operations of the embodiments, and vice versa.

Although the embodiments have been described with reference to limited drawings as above, it will be understood by those skilled in the art that various technical modifications and variations may be applied based on the foregoing description. For example, the described techniques may be performed in a different order than described, and/or components of the described systems, structures, devices, and circuits may be combined or coupled in a different form than described, or may be replaced or substituted with other components or equivalents, and appropriate results may still be achieved.

1. A simulator comprising:
one or more memories;
one or more processors; and
one or more IO hardware configured to perform input and output simulation of a simulation target system;
wherein the one or more memories stores simulator software,
the simulator software including
a model section comprising one or more logic models configured to simulate respective functional elements of the simulation target system; and
a main controller section configured to perform a simulation control function for the simulation target system according to user control commands,
wherein a portion of the one or more memories is allocated as shared memory for sharing input and output data between the one or more logic models and the one or more IO hardware,
the shared memory including respective shared memory regions individually allocated to the one or more logic models, and
wherein a main program process of the main controller section executed by the one or more processors is configured to perform sharing of the input and output data.

2. The simulator according to claim 1,
wherein the simulator software further includes:
an IO section configured to perform an IO hardware control function for controlling the one or more IO hardware; and
a MAP section configured to perform a mapping control function of generating and managing a mapping table between a memory of the one or more IO hardware and data processed by the one or more logic models.

3. The simulator according to claim 2,
wherein the portion of the one or more memories includes:
a shared memory region for data use for addition, modification, and management of the one or more logic models by a user and for execution of the one or more logic models; and
a shared memory region for control use for execution of the main controller section, the IO section, and the MAP section,
and wherein shared memory allocated as the shared memory regions for data use and for control use is configured in a memory map form.

4. The simulator according to claim 3,
wherein the model section provides an environment for designing logic and data input/output interfaces of one or more logic models for simulating respective functional elements of the simulation target system based on data of the shared memory region for data use and the shared memory region for control use.

5. The simulator according to claim 4,
wherein the simulator software further includes a UI section configured to provide a user interface that allows a user to add, modify, and manage the one or more logic models, set data mappings between the one or more logic models and the one or more IO hardware, and control and monitor a simulation according to user requirements,
and wherein the UI section is configured to control UI components constituting the user interface in association with control parameters stored in the shared memory and data processed by the one or more logic models,
and wherein the shared memory allocated as the shared memory regions for data use and for control use is configured to be referenced, displayed, and manipulated by the UI section.

6. The simulator according to claim 5,
wherein the one or more logic models are implemented as logic model processes that are independently executed,
wherein the logic model processes are executed independently of processes of the main controller section, the IO section, and the MAP section, and
wherein a main program including the main controller section, the IO section, and the MAP section is implemented as a single process.

7. The simulator according to claim 6,
wherein a shared memory region for addition, modification, and management of the one or more logic models by a user and for execution of the one or more logic models, and a shared memory region for execution of the main controller section, the IO section, and the MAP section are independently allocated and managed.

8. The simulator according to claim 6,
wherein MAP setting files for mapping control and IO setting files for IO hardware control are delivered to a process of the main controller section through a path via the shared memory, or
wherein MAP setting files for mapping control and the IO setting files for IO hardware control are directly loaded and processed by the process of the main controller section without passing through the shared memory.

9. The simulator according to claim 1,
wherein processes of the simulator software are configured to operate based on POSIX (Portable Operating System Interface) system call interface, System V system call interface, or Win32 API system call interface.

10. The simulator according to claim 7,
wherein the one or more logic models are individually allocated respective shared memory regions based on respective IDs, and
wherein data sharing between the one or more logic models is performed through the shared memory regions.

11. A non-transitory computer-readable storage medium storing instructions for executing simulator software,
the simulator software including
a model section comprising one or more logic models configured to simulate respective functional elements of a simulation target system, and
a main controller section configured to perform a simulation control function for the simulation target system according to user control commands,
wherein, when executed by one or more processors of a simulator having a memory and one or more IO hardware configured to simulate input and output of the simulation target system, the instructions cause the simulator to:
allocate a portion of the memory as shared memory for sharing input and output data between the one or more logic models and the one or more IO hardware;
manage the shared memory so that the shared memory includes respective shared memory regions individually allocated to the one or more logic models; and
execute a main program process of the main controller section by the one or more processors so as to perform sharing of the input and output data.

12. The non-transitory computer-readable storage medium according to claim 11,
wherein the simulator software further includes:
an IO section configured to perform an IO hardware control function for controlling the one or more IO hardware; and
a MAP section configured to perform a mapping control function of generating and managing a mapping table between a memory of the one or more IO hardware and data processed by the one or more logic models.

13. The non-transitory computer-readable storage medium according to claim 12,
wherein the portion of the one or more memories includes:
a shared memory region for data use for addition, modification, and management of the one or more logic models by a user and for execution of the one or more logic models; and
a shared memory region for control use for execution of the main controller section, the IO section, and the MAP section,
and wherein shared memory allocated as the shared memory regions for data use and for control use is configured in a memory map form.

14. The non-transitory computer-readable storage medium according to claim 13,
wherein the model section provides an environment for designing logic and data input/output interfaces of one or more logic models for simulating respective functional elements of the simulation target system based on data of the shared memory region for data use and the shared memory region for control use.

15. The non-transitory computer-readable storage medium according to claim 14,
wherein the simulator software further includes a UI section configured to provide a user interface that allows a user to add, modify, and manage the one or more logic models, set data mappings between the one or more logic models and the one or more IO hardware, and control and monitor a simulation according to user requirements,
and wherein the UI section is configured to control UI components constituting the user interface in association with control parameters stored in the shared memory and data processed by the one or more logic models,
and wherein the shared memory allocated as the shared memory regions for data use and for control use is configured to be referenced, displayed, and manipulated by the UI section.

16. The non-transitory computer-readable storage medium according to claim 15,
wherein the one or more logic models are implemented as logic model processes that are independently executed,
wherein the logic model processes are executed independently of processes of the main controller section, the IO section, and the MAP section, and
wherein a main program including the main controller section, the IO section, and the MAP section is implemented as a single process.

17. The non-transitory computer-readable storage medium according to claim 16,
wherein a shared memory region for addition, modification, and management of the one or more logic models by a user and for execution of the one or more logic models, and a shared memory region for execution of the main controller section, the IO section, and the MAP section are independently allocated and managed.

18. The non-transitory computer-readable storage medium according to claim 16,
wherein MAP setting files for mapping control and IO setting files for IO hardware control are delivered to a process of the main controller section through a path via the shared memory, or
wherein the MAP setting files for mapping control and the IO setting files for IO hardware control are directly loaded and processed by the process of the main controller section without passing through the shared memory.

19. The non-transitory computer-readable storage medium according to claim 11,
wherein processes of the simulator software are configured to operate based on POSIX (Portable Operating System Interface) system call interface, System V system call interface, or Win32 API system call interface.

20. The non-transitory computer-readable storage medium according to claim 17,
wherein the one or more logic models are individually allocated respective shared memory regions based on respective IDs, and
wherein data sharing between the one or more logic models is performed through the shared memory regions.
